(19) United States
(12) Patent Application Publication
(10) Pub. No.: US 2018/0123109 A1
(43) Pub. Date: May 3, 2018

(54) ELECTRICAL CONNECTION PART FOR A SECONDARY CELL

(71) Applicant: SAFT, Levallois-Perret (FR)

(72) Inventors: Thomas POUGET, Pompignac (FR); Alexandre BEUGNON, Ludon Medoc (FR)

(73) Assignee: SAFT, Levallois-Perret (FR)

(21) Appl. No.: 15/797,684

(22) Filed: Oct. 30, 2017

(30) Foreign Application Priority Data
Oct. 31, 2016 (FR) 1660570

(51) Int. Cl. H01M 2/26; H01M 10/0525

(52) U.S. Cl. CPC H01M 2/26; H01M 10/0525

(57) ABSTRACT

An electrical connection part for a secondary cell and a secondary cell that includes this part and finding particular application in the field of lithium-ion type batteries are provided. The electrical connection part for connection to a current output terminal of a secondary cell includes a first portion for connection to an electrode plate group of the secondary cell providing electrical connection between the electrode plate group and the output terminal. The first portion has contact means which set up an electrical connection with the electrode plate group of the secondary cell using mechanical contact between the two.

### FIELD OF THE INVENTION

The present invention relates to an electrical connection part for a secondary cell and to a secondary cell comprising this electrical connection part. It finds application in the field of secondary cells or storage cells of the lithium-ion type.

### BACKGROUND ART

Lithium-ion battery technology generally uses a thin metal strip or foil as a support for the electrodes, forming an electrode plate group. This strip is coated with a paste comprising the electrochemically active material. The extremity of the strip is not covered with electrochemically active material over a portion having a height of a few millimeters. This portion is used for the connection to one of the terminals of the secondary cell, using laser or ultrasonic welding to a metal connection part the function of which is to collect the current coming from the electrodes. This connection part is generally in the form of a strip (or tongue) of copper, aluminum or stainless steel, one end of it being welded to the portion of the electrode strip which is not coated with electrochemical material.

In particular, EP 2,093,820, EP 1,102,337 and EP 1,596,449 disclose examples of an electrical connection part adapted to ensure electrical connection between one of the terminals of a secondary cell and the electrode plate group by laser welding to the electrode plate group, as explained in the preceding paragraph.

In the range of wavelengths of the laser beam (about 1063 nm), the reflectivity of the metal of the connection part greatly affects the quality of the weld. If the metal of the connection part to be welded is shiny (high reflectivity), part of the laser beam will be reflected, which will affect the quality of welding, in particular in terms of mechanical strength and current collecting. Now, the passage of the current between the electrode plate group and the electrical connection part can be strongly affected if the welding is not optimal.

Moreover, even in the normal mode of operation of the secondary cell, laser welding causes considerable heating up which can cause burning of the separator and potentially lead to a loss of insulation of the electrode plate group. Such burns can cause a short circuit which makes the battery unusable.

Also, the cycle times required for the laser welding process (positioning, welding, etc.) lengthens the manufacturing process of the secondary cell. In addition, the tooling and accessories required for the laser welding operation (source, welding head fiber, etc.) increase manufacturing cost of the secondary cell in a non-negligible manner.

### SUMMARY OF THE INVENTION

One of the aims of the invention is therefore to solve in particular the aforementioned problems, by providing an electrical connection part for a secondary cell, which makes it possible in particular to ensure electrical connection with the electrode plate group of the secondary cell without the use of welding.

Thus, according to a first aspect, the invention provides an electrical connection part for connection to a current output terminal of a secondary cell and comprising a first portion for connection to an electrode plate group of the secondary cell, so as to ensure electrical connection between the electrode plate group and the output terminal.

The first portion is provided with contact means for establishing an electrical connection to the electrode plate group by mechanical contact.

In the present application, an electrical connection set up by mechanical contact should be taken to mean an electrical connection between two parts which allows the passage of electrically charged particles from one part to the other without chemical bonding between these two parts, in particular without welding and without added material such as a conductive adhesive for example.

According to certain embodiments, the connection part further comprises one or more of the following features taken individually or in any technically possible combination:

the first portion has a substantially planar shape with a face providing contact adapted to be in contact with the electrode plate group and the contact means are formed in the material of the first portion so as to project from the face providing contact up to a predetermined distance from said face providing contact;

the first portion has a substantially circular shape and the contact means are evenly distributed circularly on the face providing contact;

the first portion has a substantially circular shape and the contact means are uniformly distributed radially on the face providing contact;

the contact means comprise lamellae, one end of which is connected to the first portion of the connection part and the other end of which is free and projects at said determined distance from the face providing contact;

the lamellae extend from their end united with the first portion towards their free end in the direction of a radius of the circular shape of the first portion;

at least one portion of the lamellae extends in a first direction and at least one other portion of these lamellae extends in an opposite direction to the first direction;

the lamellae extend over the maximum available distance along a radius of the first portion;

the contact means comprise studs which extend substantially perpendicularly to the face providing contact;

the studs are distributed substantially homogeneously on the face providing contact of the first portion in a determined quantity and have a determined width so as to uniformly connect the electrodes of the electrode plate group and the face providing contact of the first portion;

the said determined quantity and width are such that the current density passing between the connection part and the electrode plate group is substantially comprised between 5 and 10 A/mm²;

the first portion is provided with a plurality of recesses distributed between the contact means and/or formed in these contact means.

the contact means are formed by sheet metal working, for example by cutting into the first portion or by stamping in the first portion from its face opposed to the face providing contact;

the connection part comprises a second portion for connection to the current output terminal of the secondary cell and the first and second portions are united by means of a region of folding;

the second portion takes the form of a substantially planar lamella.

The invention also provides, in another aspect, a secondary cell comprising an electrode plate group and a current output terminal.

The electrode plate group is connected to the output terminal by a connection part as disclosed above.

According to certain embodiments, the secondary cell further includes one or more of the following features taken individually or in any technically possible combination:

the electrical connection between the connection part and the electrode plate group is made directly by mechanical contact at the edges of said electrode plate group;

the connection between the connection part and the electrode plate group is achieved by sinking the contact means into the edges of the electrode plate group over a distance less than or equal to the determined distance of projection of the contact means from the face providing contact of the first portion of the connection part;

the electrode plate group is arranged in a container closed by a cover through which the current output terminal passes, a part having a packing function being arranged between the face of the first portion of the connection part opposed to its face providing contact and the cover, so as to increase homogeneity of contact between the first portion of the connection part and the electrode plate group, the part having a packing function being capable of compensating for a temporary clearance between the first portion of the connection part and the electrode plate group;

the electrode plate group is of the lithium ion type.

Thus, the connection part of the invention provides optimum electrical connection with the electrode plate group of the secondary cell through mechanical contact.

This mechanical contact, notably avoiding the use of welding, eliminates variability in mechanical strength and in the contact itself, as well as separator burns. It also makes it possible to reduce the time and cost of manufacturing a secondary cell in a non-negligible manner.

The characteristics and advantages of the invention will become apparent on reading the following description, given by way of example and not by way of limitation, with reference to the following figures.

### BRIEF DESCRIPTION OF THE DRAWINGS

FIG. 1 is a diagrammatic representation of a secondary cell according to the invention, comprising an electrical connection part according to the invention;

FIG. 2 is a diagrammatic representation of a first example of an electrical connection part according to the invention;

FIG. 3 is a diagrammatic representation of a second example of an electrical connection part according to the invention;

FIG. 4 is a diagrammatic representation of a third example of an electrical connection part according to the invention.

### DETAILED DESCRIPTION OF PREFERRED EMBODIMENTS

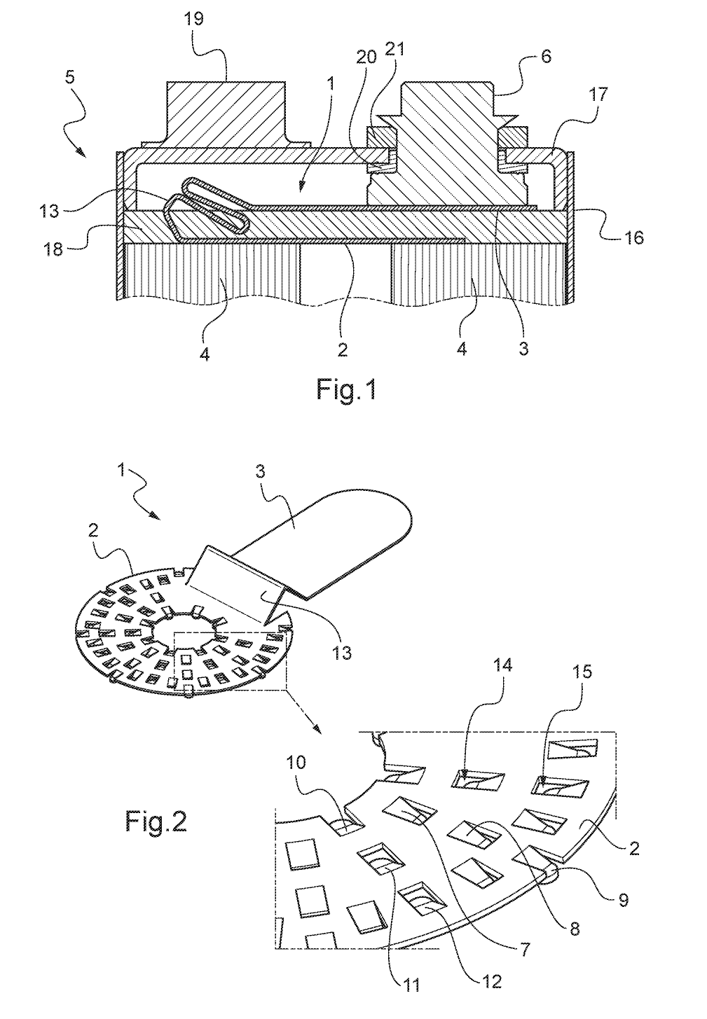

FIG. 1 shows, partially, an example of a secondary cell according to the invention provided with an example of a connection part also according to the invention.

The secondary cell 5 comprises an electrode plate group 4, for example of the lithium-ion type, comprising an alternation of positive and negative electrodes arranged on either sides of electrolyte-impregnated separators. Typically, each electrode is composed of a metal current collector, often referred to as a strip or foil, carrying the electrochemically active material on at least one of its faces.

The electrode plate group 4 is arranged in a sealed container 16 which may, for example, be cylindrical or prismatic, having a wall covered at one end of the container by a cover 17 which supports current output terminals 6 and 19. The other end of sealed container 16, not shown in FIG. 1, is sealed by a bottom.

A first current output terminal, in the example the positive terminal 19, is generally welded to the cover 17. A second current output terminal, in the example the negative terminal 6, passes through the cover 17. It is generally secured thereto by fastening means 21 using crimping or screwing, and seals 20 electrically insulate this negative current output terminal 6 from the cover 17.

The current output terminals 17, 19 provide electrical continuity between the electrodes of the electrode plate group 4 and the external application with which the secondary cell 5 is associated.

An electrical connection part 1 connects the negative electrodes of the electrode plate group 4 to the negative current output terminal 6. This connection part 1 has a first portion 2 connected to the electrode plate group 4 and a second portion 3 connected to the output terminal 6.

The connection between the first portion 2 of connection part 1 and the electrode plate group 4 is obtained by contact means which are not shown in FIG. 1, for the purpose of simplifying FIG. 1, but which will be described hereinafter in more detail with reference to FIGS. 2 to 4, which show various embodiments of connection part 1. These contact means are adapted to ensure electrical connection between the first portion 2 of connection part 1 and the electrode plate group 4, by mechanical contact.

As can be seen in FIG. 1 in particular, the first portion 2 and the second portion 3 of the connection part 1 can be united by means of a region of folding 13. This region of folding 13 facilitates, in particular, closure of the secondary cell 5 during the assembly of the latter.

Alternatively, in the case of what we shall call herein a direct connection, the connection part 1 comprises only one portion 2 without a region of folding 13 connecting this portion 2 to another portion 3. In this case, the connection between the terminal 6 and the connection part 1 is made by the face of this connection part 1, and therefore by means of its single portion 2, opposed to the face providing contact of this portion 2 which is arranged to be in contact with the electrode plate group 4. The terminal 6 is then in direct contact with the connection part 1, and therefore with its single portion 2, by its face opposed to the face providing contact. This direct contact between the terminal 6 and the connection part 1 can be obtained, for example, by welding, or else by means of a mechanical connection ensuring contact.

The connection between connection part 1 and the electrode plate group 4 is thus made directly by mechanical contact at the edges 4 of the electrodes of the electrode plate group 4. Preferably, these edges 4 are flattened, in accordance, for example, with which is described in EP 1,596,449.

A part having a packing function 18 disposed between the connection part 1 and the cover 17 can be provided in order to increase homogeneity of contact between the first portion 2 of connection part 1 and the electrode plate group 4. This part having a packing function 18, which is preferably of plastics material such as polypropylene (PP) or polybutylene terephthalate (PBT), or of a polyetherimide (PEI), and which can take the form of a packing ring 18, is capable of compensating for temporary clearance between the first portion 2 of connection part 1 and the electrode plate group 4.

It is also possible to arrange for directly incorporating means for compensating for clearance into the connection part 1, making use of the resilient properties of the metal composing this connection part 1.

Eliminating clearance in this way thus makes it possible to attenuate potential resonance or shock due to internal masses colliding and compensate for any variations in the height of the electrode plate group 4 from one secondary cell 5 to the other.

FIGS. 2 to 4 show respectively three embodiments of a connection part 1 according to the invention, which can be used in a secondary cell 5 as shown in FIG. 1.

In these examples, the first portion 2 of connection part 1 is substantially planar and united by the region of folding 13 with the second portion 3 which takes the form of a lamella 3 which is also substantially planar.

Thus, in these examples, the face providing contact of the first portion 2 adapted to be in contact with the electrode plate group 4, and the face of the second portion 3 adapted to be in contact with the terminal 6 are on the same side of connection part 1, that is to say they correspond to two portions of the same face of the connection part 1.

In contrast, in the alternative direct connection discussed above, the face providing contact of the single portion 2 and the face of this single portion 2 adapted to be in contact with the terminal 6 respectively form part of two opposing faces of the connection part 1.

In all cases, on its face providing contact adapted to be in contact with the electrode plate group 4, the first portion 2 of the connection part 1 is provided with contact means 7 to 12 which are formed in the material of first portion 2, by sheet metal working, for example by stamping or by cutting out, so as to project from the face providing contact by a determined distance from this face providing contact.

Preferably, in particular in the case of use in a cylindrical secondary cell 5, the first portion 2 of connection part 1 has a substantially circular shape. The contact means 7 to 12 are then uniformly distributed in a circular manner over the face providing contact of the first portion 2. Also, or alternatively, these contact means 7 to 12 can be uniformly distributed radially over the face providing contact of this first portion 2.

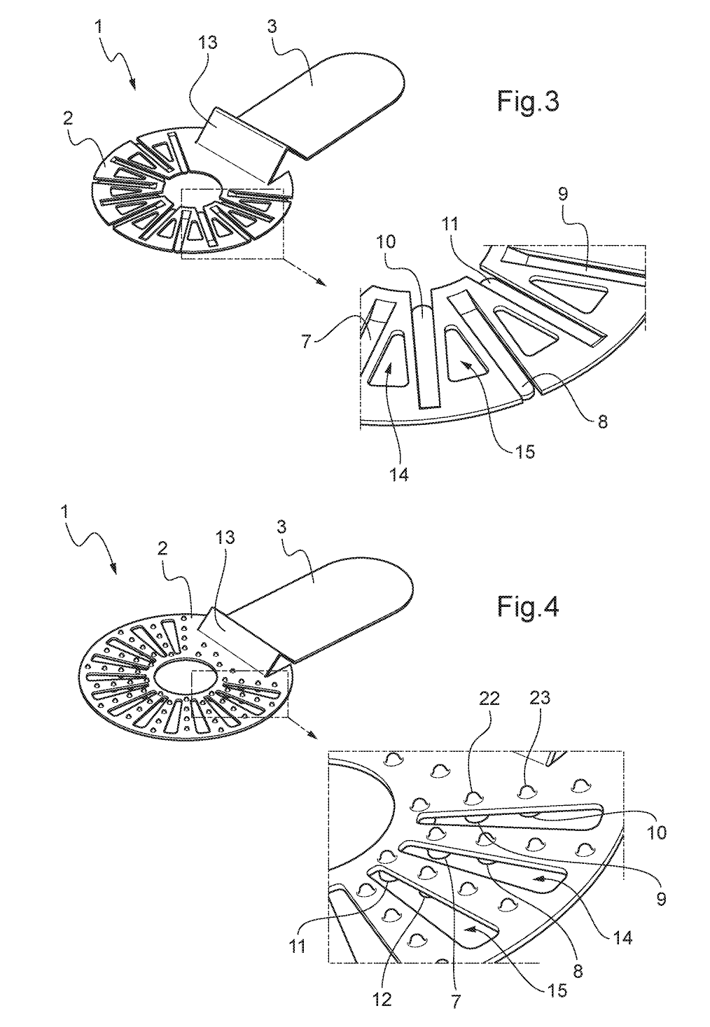

In the examples of FIGS. 2 and 3, the contact means 7 to 12 comprise lamellae 7 to 12. Each lamella 7 to 12 has a first portion integral with the first portion 2 of the connection part 1 and a free opposing end which projects at a determined distance from the face providing contact of this first portion 2.

As is the case in these two examples of FIGS. 2 and 3, the lamellae 7 to 12 can be oriented radially, that is to say they extend from their end integral with the first portion 2 of connection part 1 towards their free end in the direction of a radius of the substantially circular shape of this first portion 2.

It can be arranged for the radial orientation of these lamellae 7 to 12 to be alternated, which facilitates connection with the edges 4 of the electrodes which are at different diameters with respect to a central axis of symmetry of the secondary cell 5.

Thus, in the example shown in FIG. 2, the lamellae 10, 11 and 12 are oriented radially in a first direction and the lamellae 7, 8 and 9 are oriented radially in the opposite direction with respect to the first direction. Similarly, in the example shown in FIG. 3, the lamellae 10 and 11 are oriented radially in a first direction and the lamellae 7, 8 and 9 are oriented radially in the opposite direction with respect to the first direction.

In the particular case of the example of FIG. 3, the lamellae 7 to 11 extend over the maximum distance available along a radius of the first portion 2, i.e. they are formed by a cut in the first portion 2 of connection part 1 starting from a point near an outer or inner edge right up to the opposite edge.

In this variant of FIG. 3, taking account of the length of the lamellae 7 to 11, a certain degree of resilience of these lamellae 7 to 11 is obtained, which makes it easier to compensate for clearance as explained above.

FIG. 4 shows another embodiment, in which the contact means 7 to 12 take the form of studs 7 to 12 which extend substantially perpendicularly to the face providing contact of the first portion 2 of connection part 1.

These studs 7 to 12 are obtained by stamping the face of the first portion 2, opposed to its face providing contact. Stamping creates hollows, such as the recesses 22, 23 on this face opposed to the face providing contact, and creates the corresponding studs, such as the studs 9, 10, on the face providing contact.

Homogeneous distribution of the studs 7 to 12 of a determined width and quantity on the face providing contact of the first portion 2 of the connection part 1, ensures uniform electrical connection between the electrodes of the electrode plate group 4 and the face providing contact of the first portion 2 of connection part 1.

Preferably, the determined width and the determined quantity of studs 7 to 12 is such that the density of the current passing between the connection part 1 and the electrode plate group 4 is substantially between 5 and 10 A/mm².

By way of example, for a first portion 2 having a substantially circular surface area of the order of 700 to 40000 mm², it is envisaged to distribute 15 to 100 studs of a width or diameter of the order of 1 to 3 mm.

Generally speaking, regardless of the embodiments, homogeneous distribution of the contact means 7 to 12 with a determined geometry and in a determined quantity on the face providing contact of the first portion 2 of the connection part 1, ensures uniform electrical connection between the electrodes of electrode plate group 4 and the face providing contact of the first portion 2 of the connection part 1.

Whatever the embodiments, the contact means 7 to 12 have such a geometry and are present in such a number that the current density passing between connection part 1 and the electrode plate group 4 is substantially between 5 and 10 A/mm².

The first portion 2 of the connection part 1 is further provided with recesses 14, 15. These recesses 14, 15 make it possible to increase the resilience and the flexibility of the first portion 2, which facilitates homogeneity of the electrical connection when the contact surface suffers from a flatness defect. Furthermore, these recesses allow the evacuation of gases which are formed during electrochemical operation of the secondary cell.

In the example of FIG. 2, the recesses 14, 15 are formed directly by the cutting of the lamellae 7 to 12.

In the respective examples of FIGS. 3 and 4, these recesses 14, 15 are formed between the contact means 7 to 12, that is to say in the material of the first portion 2, between the lamellae 7 to 11 of FIG. 3 or between the studs 7 to 12 of FIG. 4.

Thus, the invention advantageously replaces electrical connection made by welding between connection part 1 and the edges of the electrodes of the electrode plate group 4 by mechanical contact. When the first portion 2 of connection part 1 is pressed on the edges of the electrodes of the electrode plate group 4, the contact means 7 to 12, such as the lamellae 7 to 12 of FIG. 2, the lamellae 7 to 11 in FIG. 3, or the studs 7 to 12 in FIG. 4, sink into the edges of the electrodes to a degree equal to the difference in level between the ends of these contact means 7 to 12 and the face providing contact of the first portion 2.

Obviously, the present invention is not limited to the embodiments described by way of example above. Thus, the invention is not limited to application to a cylindrical or prismatic secondary cell 5.

Moreover, the exact shape of the contact means 7 to 12 does not limit the invention. The design of the lamellae 7 to 12 has an influence on their rigidity and therefore on their ability to elastically shift towards or away from the face providing contact of the first portion 2, away from an initial position and to return to this initial position. Other forms of lamellae other than those shown in FIGS. 2 and 3 can make it possible to achieve this objective.

1. An electrical connection part for connection to a current output terminal of a secondary cell, said connection part comprising a first portion for connection to an electrode plate group of said secondary cell so as to provide electrical connection between said electrode plate group and said output terminal, wherein the said first portion is provided with contact means for establishing an electrical connection with said electrode plate group by mechanical contact.

2. The connection part as claimed in claim 1, wherein the first portion has a substantially planar shape with a face providing contact adapted to be in contact with the electrode plate group and in that the said contact means are formed in the material of the first portion so as to project from the face providing contact up to a predetermined distance from said face providing contact.

3. The connection part as claimed in claim 2, wherein the first portion has a substantially circular shape and the contact means are uniformly distributed in a circular manner over the face providing contact.

4. The connection part according to claim 2, wherein the first portion has a substantially circular shape and in that the contact means are uniformly distributed radially on the face providing contact.

5. The connection part according to claim 2, wherein the contact means comprise lamellae, one end of which is connected to the first portion of the connection part and another end of which is free and projects at said determined distance from said face providing contact.

6. The connection part according to claim 5,
wherein the first portion has a substantially planar shape with a face providing contact adapted to be in contact with the electrode plate group and in that the said contact means are formed in the material of the first portion so as to project from the face providing contact up to a predetermined distance from said face providing contact, and
wherein the lamellae extend from their end united with the first portion towards their free end in the direction of a radius of the circular shape of the first portion.

7. The connection part according to claim 6, wherein at least one portion of the lamellae extends in a first direction and at least one other portion of these lamellae extends in an opposite direction to the first direction.

8. The connection part according to claim 6, wherein the lamellae extend over the maximum available distance along a radius of the first portion.

9. The connection part according to claim 2, wherein the contact means comprise studs that extend substantially perpendicularly to the face providing contact.

10. The connection part according to claim 9, wherein the studs are distributed substantially homogeneously on the face providing contact of the first portion in a determined quantity and have a determined width, so as to establish uniform electrical connection between the electrodes of the electrode plate group and the face providing contact of the first portion.

11. The connection part as claimed in claim 10, wherein the determined quantity and width are such that a current density passing between the connection part and the electrode plate group is substantially comprised between 5 and 10 A/mm².

12. The connection part according to claim 1, wherein the first portion is provided with a plurality of recesses distributed between the contact means and/or formed in said contact means.

13. The connection part according to claim 1, wherein the contact means are formed by sheet metal working, for example by cutting in the first portion or by stamping in the first portion, part from its face opposed to the face providing contact.

14. The connection part according to claim 1, wherein it comprises a second portion for connection to the current output terminal of the secondary cell, and in that the first and the second portions are united by means of a region of folding.

15. The connection part as claimed in claim 14, wherein the second portion takes the form of a substantially planar lamella.

16. A secondary cell comprising an electrode plate group and a current output terminal, wherein the electrode plate group is connected to the output terminal by means of a connection part according to claim 1.

17. The secondary cell according to claim 16, wherein the electrical connection between the connection part and the electrode plate group is made directly by mechanical contact at the edges of said electrode plate group.

18. The secondary cell according to claim 17, wherein the first portion has a substantially planar shape with a face providing contact adapted to be in contact with the electrode plate group and in that the said contact means are formed in the material of the first portion so as to project from the face providing contact up to a predetermined distance from said face providing contact, and
wherein the connection between the connection part and the electrode plate group is made by sinking the contact means into the edges of said electrode plate group over a distance less than or equal to the determined distance of projection of the contact means from the face providing contact of the first portion of the connection part.

19. The secondary cell according to claim 16, wherein the electrode plate group is disposed in a container closed by a lid through which a current output terminal passes, wherein between the cover and the face of the first portion of the connection part opposed to its face providing contact, a part having a packing function is arranged, adapted to increase the homogeneity of contact between the first portion of the connection part and the electrode plate group, said part having a packing function being capable of compensating for temporary clearance between the first portion of the connection part and the electrode plate group.

20. The secondary cell according to claim 16, wherein the electrode plate group is of the lithium ion type.
